(19) United States
(12) Patent Application Publication
(10) Pub. No.: US 2014/0166108 A1
(43) Pub. Date: Jun. 19, 2014

(54) Microfluidic Platform

(71) Applicants: Tobias Rodenfels, Dortmund (DE); Thanh Tu Hellmich-Duong, Jena (DE); Gert Blankenstein, Arlington, MA (US)

(72) Inventors: Tobias Rodenfels, Dortmund (DE); Thanh Tu Hellmich-Duong, Jena (DE); Gert Blankenstein, Arlington, MA (US)

(73) Assignee: BOEHRINGER INGELHEIM MICROPARTS GMBH, Dortmund (DE)

(21) Appl. No.: 13/877,720

(22) PCT Filed: Oct. 4, 2011
(86) PCT No.: PCT/EP2011/067340

§ 371 Date: Nov. 15, 2013

(30) Foreign Application Priority Data
Oct. 7, 2010 (EP) 10186837.0

(51) Int. Cl. B01L 3/00

(52) U.S. Cl. CPC B01L 3/50273
USPC 137/1; 422/504

(57) ABSTRACT

The invention relates to a microfluidic platform (1) having at least one means (12) for initiating a movement of a liquid (P), in particular a sample liquid, between at least two locations (100, 101) of the microfluidic platform (1).

It is proposed according to the invention that the means (12) is embodied as an element of changeable volume and/or shape and is mounted on a cover-like component (11) that is movably connected to the microfluidic platform (1). By moving of the component (11) the element (12) can be brought into a position such that, by changing its volume and/or shape, it causes the liquid (P) situated at the location (100) to be moved at least partly from this location (100) to the other location (101).

In this way a sample liquid (P) can be transferred from a sample application point (100) to a sample utilisation area (101) in a very simple and reliable manner.

The invention further proposes a method by which a movement of a liquid between two locations can be initiated, while this can be done in particular using a microfluidic platform (1) according to the invention.

The present invention relates to a microfluidic platform having at least one means for initiating a movement of a liquid, in particular a sample liquid, between at least two locations of the microfluidic platform.

The term “microfluidic platform” in the present invention is meant to encompass all objects or devices in which sample liquids that are to be investigated or manipulated can be accommodated in cavities and can be transported by suitable means (for example, capillary forces acting in microchannels) to reaction locations that are provided accordingly.

In particular, the present invention encompasses microfluidic platforms such as, for example, sample carriers, test strips, biosensors or the like, which may be used for carrying out individual tests or measurements. For example, biological liquids (e.g., blood, urine or saliva) may be investigated on the one hand for pathogens or incompatibilities but also on the other hand for their content of, for example, glucose (blood sugar) or cholesterol (blood fat). For this purpose corresponding detection reactions or whole cascades of reactions take place on the microfluidic platforms.

For these, it is necessary for the biological sample liquid to be transported by suitable means to the reaction location or locations provided for this purpose. This transporting of the sample liquid may, for example, be effected by passive capillary forces (by corresponding capillary systems or microchannels) or by an active actuating system.

The active actuating system used may be, for example, injection or diaphragm pumps which may be located outside the microfluidic platform or on said platform.

Generally, microfluidic platforms have a sample application area of the order of a few millimetres in size for the application of a quantity of sample liquid of the order of a few microlitres, the sample liquid (e.g., blood) having to be transported through a microchannel or a microchannel system to corresponding sample utilisation areas or reaction locations. This transporting or this movement of the sample liquid should take place reliably and in a simple manner.

DE 10 2004 050 062 A1 describes, for example, microfluidic platforms of this kind, while a plurality of usable platforms may be joined together as an endless strip and may be individually detached from the strip for use. The sample liquid is transported here exclusively by means of capillary forces.

DE 20 2009 008 052 U1 describes a microfluidic platform, in which both capillary forces and also an active element in the form of a pressure source are used as means for initiating a movement of a sample liquid or for transporting said liquid. The device shown is intended to be able to control transport processes in the microfluidic system precisely and safely, while the manufacturing costs for the microfluidic platform are to be kept comparatively low.

The problem of the present invention is to provide an alternative microfluidic platform of the generic type, with which at least a portion of a liquid, in particular a sample liquid, can be transported between two locations on the microfluidic platform reliably and in an easily manageable manner.

The at least two locations may be, for example, on the one hand, a sample application area in which a sample liquid is applied, and on the other hand a sample utilisation area or reaction area to which the sample liquid is to be transported and undergo a specific detection reaction therein with suitable reagents. Both the sample application area and the sample utilisation area may be embodied as cavities.

The problem stated above is solved by the characterising features of claim 1. Advantageous embodiments or further features of the invention can be inferred from the respective subclaims.

The invention starts from a microfluidic platform with at least one means for initiating a movement of a liquid, in particular a sample liquid, between at least two locations of the microfluidic platform.

It is now provided according to the invention that the at least one means comprises at least one element of changeable volume and/or shape, which is mounted on at least one component movably connected to the microfluidic platform and, by movement of the component, can be brought into a position such that the element, by changing its volume and/or shape, causes the liquid located at the at least one location to be at least partly moved from this location to the at least one other location.

By this measure it is very easy to move a liquid between two locations of a microfluidic platform without the need for external equipment (e.g., external pumps) essentially independent of the microfluidic platform. Naturally, additional capillary channels may be provided on the microfluidic platform, in which the liquid is transported purely passively by capillary forces.

It has proved very convenient if the at least one element of changeable volume and/or shape can be brought, by movement of the component, into a position such that the element, by increasing in volume, at least partly fills at least one cavity or, by decreasing in volume, at least partly re-opens at least one cavity that has previously been formed by the element or such that, as the element changes shape, the volume of at least one cavity that is at least partly delimited by the element can be changed.

An essential feature here is therefore the element of changeable volume and/or shape. When it at least partly fills at least one cavity, having increased in volume, the cavity may preferably be a sample application area of the microfluidic platform.

If this sample application area contains sample fluid that has been introduced previously, this sample liquid is displaced out of the sample application area, in accordance with the increase in the volume of the element into the sample application area, and can be transported in the direction of a sample utilisation area, for example.

The element which thus changes its volume and to a certain extent its shape as well, is thus a component for producing a kind of overpressure pump for transporting a sample from a sample application area to a sample utilisation area.

Conversely, however, it is also possible that the element decreases in volume and at least partly frees up at least one cavity that has previously been at least partly filled by the element. In this case, a vacuum is formed by the volume that has been freed up in the cavity. If the cavity is fluidically connected (for example, via corresponding microchannels) to a sample utilisation area and the latter is in turn connected to a sample application area, this initiates transfer of a sample liquid that has been delivered to the sample application area, in the direction of the sample utilisation area or in the direction of the said freed-up cavity.

In this case the element of changeable volume and/or shape thus serves as a kind of vacuum pump for transporting the sample liquid.

Finally, it is also possible for the element to be changeable only in its shape and for it to at least partially define a cavity in a specific position. A sample application area may, for example, be part of the cavity, which is at least partially delimited by the element of changeable shape. If the element of changeable shape, which may, for example, be configured as a membrane, is then pushed into the cavity, the volume of the cavity bounded by the element of changeable shape is reduced.

This produces a kind of manual diaphragm pump, which is integrated in the microfluidic platform and in turn is able to initiate transport of the sample liquid to a sample utilisation area that is fluidically connected to the sample application area.

With the reduction in pressure on the membrane-like element that is changeable in shape, the volume of the cavity that is at least partly bounded by this element is increased again, so that it is possible to transport a liquid in the opposite direction, i.e., back towards the cavity that is at least partly bounded by the element. Corresponding applications may be envisaged.

It has proved very advantageous if the component is embodied as a cover and in at least one position covers at least one cavity. Expediently, the cover-like component may be arranged to cover the microfluidic platform at least from two opposite sides.

If the cavity is a sample application area, for example, the movement of the cover-like component triggers a dual function, so to speak. On the one hand, the transporting of a sample solution applied to the sample application area is brought about by the element of changeable volume and/or shape, and on the other hand at the same time the sample application area is covered and in this way subsequent contamination of the sample liquid, for example, by the user or by contamination of the environment by the sample liquid, is reliably prevented.

The microfluidic platform can be configured to be particularly easy to handle if the cover-like component is connected to the microfluidic platform so as to be slidable or pivotable therewith.

Expediently, at least one sealing means may be provided such that, in the at least one position of the cover-like component that covers at least one cavity, the covered cavity is outwardly sealed off. This reinforces the effect of the element of changeable volume and/or shape.

It is very useful if the sealing means is provided on the cover-like component on the side facing the at least one cavity that is to be covered. Alternatively, the sealing means could also be provided on the microfluidic platform, specifically around the cavity that is to be covered. The sealing means used may be, for example, a film-like seal which can correspondingly be adhered to the area that is to be sealed off. However, other shapes of seal are also possible, such as, for example, lip-like seals.

According to an advantageous further feature of the invention, it is envisaged that the cover-like component has at least one cavity or opening, in which the at least one element of changeable volume and/or shape is at least partially held. In this way, the element can easily be carried with it during movement of the cover-like component.

In particular, it is expedient if the element of changeable volume and/or shape is compressed in a first position of the cover-like component that opens up the cavity and the cover-like component can be moved into a second position in which the cavity is sealingly covered and the element of changeable volume and/or shape has relaxed into the cavity, the cavity being fluidically connected to at least one other cavity, particularly a sample utilisation area.

The cavity may advantageously be embodied as a sample application area of a technical medical measuring instrument, for example, a biosensor, a test strip or the like. When the element of changeable volume and/or shape expands into the sample application area after corresponding movement of the cover-like component, the sample liquid is forced in the direction of the sample utilisation area.

It may be envisaged according to another embodiment of the invention that, in a first position of the cover-like component, the element of changeable volume and/or shape is relaxed into a cavity of the microfluidic platform and the cover-like component can be brought into a second position, sealingly covering the cavity, in which the element of changeable volume and/or shape has opened up the cavity and has been compressed, while the cavity of the microfluidic platform is fluidically connected to at least one other cavity, particularly to a sample utilisation area and a sample application area.

According to this further feature, during the movement of the cover-like component, a sample liquid applied to the sample application area is transported towards the cavity that has been opened up, i.e., therefore towards the sample utilisation area as well.

In order to ensure easy movement of the cover-like component it is expedient that the element of changeable volume and/or shape should have bevels on the side facing the cavity. According to yet another further feature of the invention, the element of changeable volume and/or shape is of membrane-like configuration and the cover-like component can be brought into a position, in which at least one cavity is sealingly covered and in which the membrane-like element at least partly defines a cavity, while by applying pressure to the membrane-like element it is possible to reduce the volume of the cavity which is thereby at least partly restricted. This further feature makes it possible in particular to produce a diaphragm pump which is virtually integrated in the cover-like component.

It is naturally also possible for the microfluidic platform advantageously to comprise a plurality of cavities and for a plurality of elements that are changeable in volume and/or shape to be provided, which are mounted on the at least one component that is movably connected to the microfluidic platform. In this way, for example, a plurality of (possibly different) sample liquids can be applied, for example, to several sample application areas and with a movement of the component a movement of the sample liquid in the manner described previously can be initiated.

However, the invention does not relate only to a microfluidic platform as described, but also to a method of initiating a movement of a liquid, particularly a sample liquid, between at least two locations of a microfluidic platform, in particular using a microfluidic platform according to the invention.

According to the invention the method comprises at least the following steps:
at least one cavity is sealingly covered with at least one component that is movably connected to the microfluidic platform
at least one element of changeable volume and/or shape, mounted on the at least one component which is movably connected to the microfluidic platform, is changed in its volume and/or shape such that a liquid contained in the at least one cavity is at least partly moved out of the cavity or in that a liquid is moved at least in the direction of this cavity.

The method according to the invention very reliably allows the initiation of a movement of a liquid between at least two locations of a microfluidic platform.

In an advantageous embodiment of the method, it may be envisaged, for example, that the at least one element of changeable volume and/or shape is brought, by the movement of the component, into a position such that, with an increase in volume, the element at least partly fills the at least one cavity, or, with a decrease in volume, at least partly frees up the at least one cavity which has previously been at least partly filled by the element or, with a change in the shape of the element, the volume of at least one cavity at least partly defined by the element is changed.

In particular, three further features of the method according to the invention may advantageously be envisaged.

It may be envisaged that the element of changeable volume and/or shape is compressed in a first position of the cover-like component that opens up the cavity, and the cover-like component is brought into a second position in which the cavity is sealingly covered and the element of changeable volume and/or shape relaxes into the cavity, the cavity being fluidically connected to at least one other cavity, particularly a sample utilisation area.

However, the method may advantageously be embodied so that the element of changeable volume and/or shape in a first position of the cover-like component is relaxed into a cavity of the microfluidic platform and the cover-like component is brought into a second position that sealingly covers the cavity, in which the element of changeable volume and/or shape has freed up the cavity again and has been compressed, the cavity of the microfluidic platform being fluidically connected to at least one other cavity, particularly to a sample utilisation area and a sample application area.

A third advantageous embodiment of the method may provide that the element of changeable volume and/or shape is of membrane-like configuration and the cover-like component is brought into a position, in which at least one cavity is sealingly covered and in which the membrane-like element delimits the at least one cavity at least partly, while as a result of pressure on the membrane-like element the volume of the at least one cavity that is thereby limited at least in parts is reduced.

Further advantages and embodiments of the invention will be illustrated by means of embodiments by way of example, which are described in more detail with the aid of the accompanying drawings, wherein

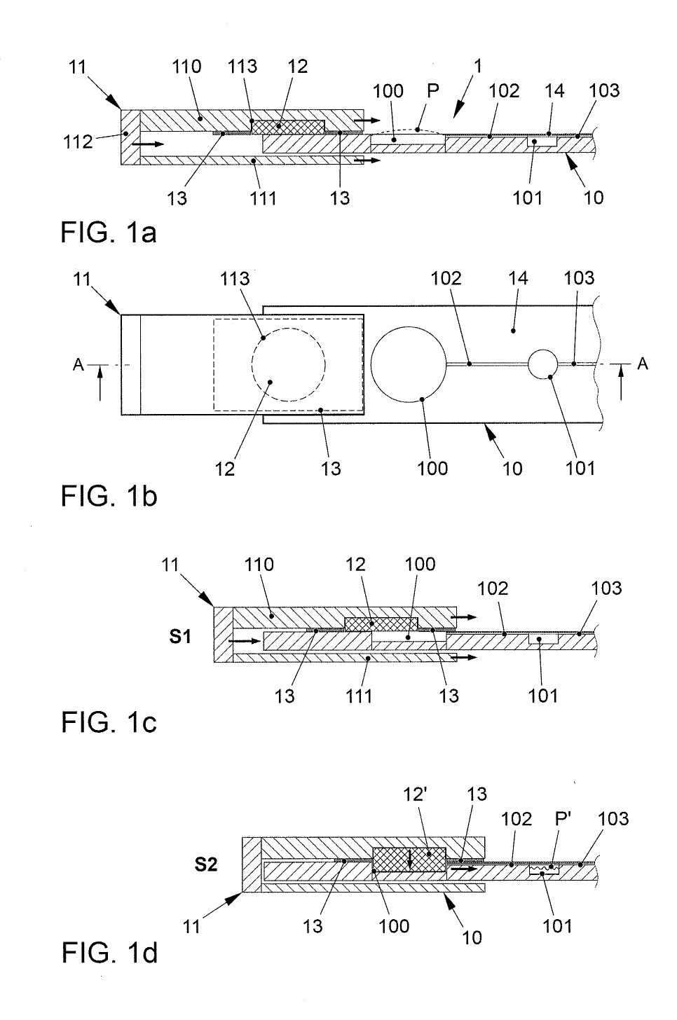

FIG. 1 a is a diagrammatic representation of a microfluidic platform according to the invention (preferred embodiment) in sectional view along section line A from FIG. 1b with an element of changeable volume and/or shape compressed,

FIG. 1b is a plan view of the microfluidic platform according to FIG. 1a,

FIG. 1c is a view of the microfluidic platform according to FIG. 1a, in which a movable cover has already been partly pushed along,

FIG. 1d is another view according to FIG. 1a, wherein the cover of the microfluidic platform has been pushed along to the end stop, with the element of changeable volume and/or shape expanded,

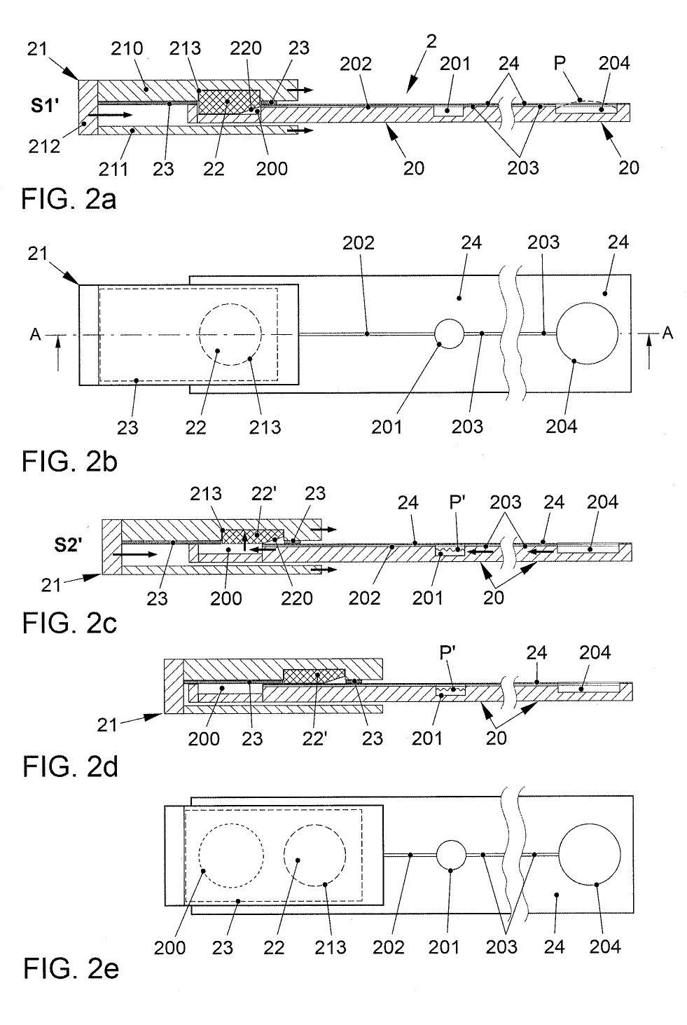

FIG. 2a is a second embodiment of a microfluidic platform according to the invention in a diagrammatic sectional view along section line A in FIG. 2b, with the element of changeable volume and/or shape relaxed,

FIG. 2b is a plan view of the microfluidic platform according to FIG. 2a,

FIG. 2c is a representation of the microfluidic platform according to FIG. 2a, wherein a cover of the microfluidic platform has already been partly moved along, with the element of changeable volume and/or shape having already been compressed,

FIG. 2d is also a representation according to the view in FIG. 2a, wherein the cover of the microfluidic platform has been pushed along to the end stop,

FIG. 2e is a view of the microfluidic platform in the position shown in FIG. 2d from above,

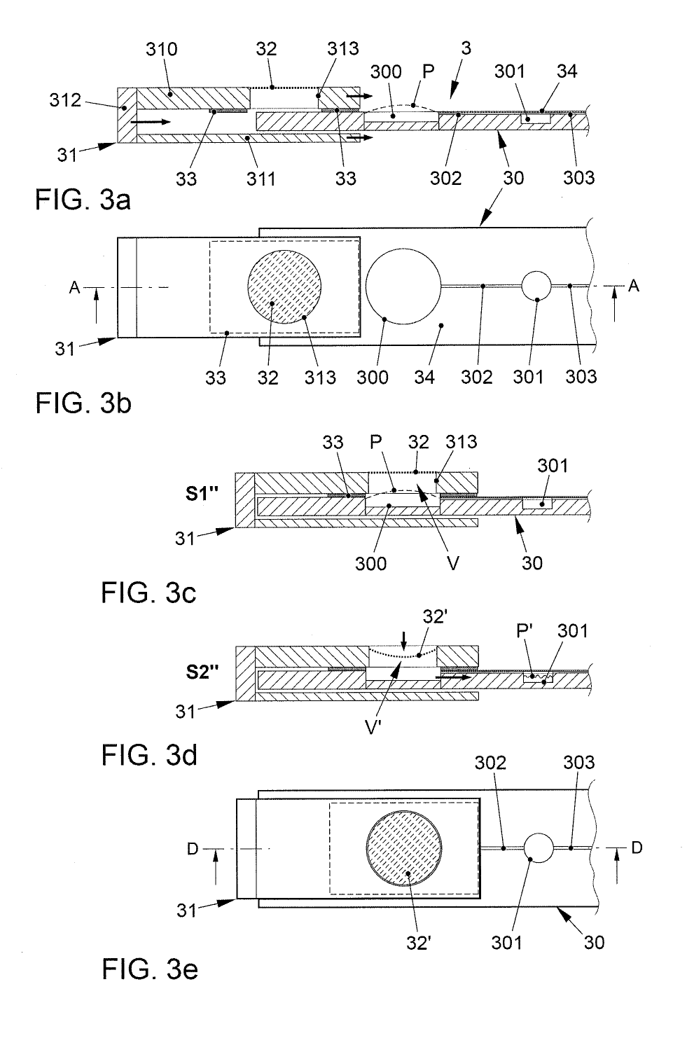

FIG. 3a is a third embodiment of a microfluidic platform according to the invention in a lateral sectional view along section line A from FIG. 3b with the element of changeable volume and/or shape undeformed,

FIG. 3b is a view of the microfluidic platform according to FIG. 3a from above,

FIG. 3c is a view of the microfluidic platform according to FIG. 3a, wherein a cover of the microfluidic platform has been pushed along to the end stop,

FIG. 3d is a view of the microfluidic platform according to the view in FIG. 3c, wherein the element of changeable volume and/or shape (membrane) has been pressed down (deformed),

FIG. 3e is a plan view of the microfluidic platform in the position according to FIG. 3d,

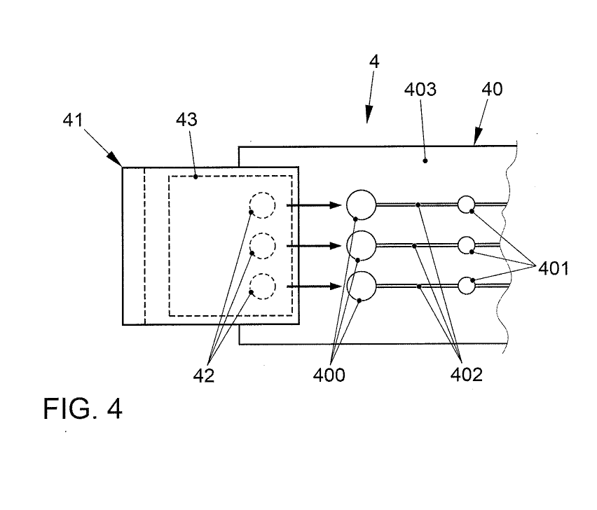

FIG. 4 is a fourth embodiment of a microfluidic platform according to the invention in diagrammatic plan view.

Reference will be made first to FIG. 1a to d. A microfluidic platform in the form of a biosensor 1 is shown. The biosensor 1 comprises a base member 10 only part of which is shown, namely the area that is relevant to the invention. The base member 10 is a comparatively flat component which is rectangular in plan view (cf. FIG. 1b) and which is provided, in the detail shown, with a sample application area 100 and a sample utilisation area 101. The sample application area 100 and the sample utilisation area 101 are formed, in plan view, by substantially circular cavities.

The sample application area 100 serves for the application of a sample liquid P (shown by dashed lines) which is connected via a microchannel 102 to the sample utilisation area 101. The sample utilisation area 101 may, for example, contain reagents, so that sample liquid P entering the sample utilisation area 101 causes corresponding detection reactions for detecting a particular analyte. The sample utilisation area 101 in turn may be provided, via a microchannel 103, with other cavities or venting means (not shown in detail).

The cavity of the sample application area 100 is opened upwards to receive the sample P. The sample utilisation area 101 and also the microchannels 102, 103 are covered at the top by a thin cover film 14 which may, for example, be adhered to the base member 10. On the left hand side, the base member 10 is movably connected to a movable cover 11 which is substantially rectangular in outline, in plan view. The cover 11 has an upper cover part 110, a lower cover part 111 and a rear cover wall 112. The above-mentioned parts of the cover 11 may be both connected to one another in multiple sections and also formed in one piece.

It can be seen that the left-hand end of the base member 10 is accommodated between the upper part 110 and the lower part 111 of the cover 11. In FIGS. 1a and 1b the cover 11 is in an extended position, in which it does not cover the sample application area 100, i.e., exposes it, so that a sample liquid P can be added to the sample application area 100 from above.

It is also apparent that a substantially circular recess 113 has been provided in the upper cover part 110, in which an element 12 of changeable volume and/or shape is held. The element 12 may be adhesively attached to the upper cover part 110 on its upper side, for example. Preferably, the element 12 of changeable volume and/or shape is made of compressible or deformable synthetic material, for example, foam or rubber.

In order to move the sample liquid P applied to the sample application area 100, or at least some of said liquid P, towards the sample utilisation area 101, the biosensor 1 shown operates as follows:

After the sample liquid P has been placed in the sample application area 100 (FIG. 1a) the movable cover 11 is pushed to the right in the direction of the base member 10 (FIG. 1c, first process step S1). As this happens the cavity of the sample application area 100 is covered by the upper cover part 110, so that the sample liquid P located in the sample application area 100 can no longer escape upwards or outwards from the sample application area 100. More precisely, the cavity of the sample application area 100 is substantially sealingly covered. A sealing covering of the sample application area 100 by the cover 11 is reinforced by a seal 13 which is mounted on, preferably adhered to, the underside of the upper cover part 110, facing the sample application area 100. The seal 13 is preferably of a film-like configuration and has a substantially rectangular shape, in plan view, which surrounds the recess 113 of the upper cover part 110. Only a substantially circular recess is required, to enable the element 12 of changeable volume and/or shape to pass through.

In the position shown in FIG. 1c, the cavity of the sample application area 100 is already substantially sealed off, but the element 12 of changeable volume and/or shape is still in a compressed or tensioned state.

If the cover 11 is now pushed further to the right (FIG. 1d, second process step S2) the element 12 held in the cover 11 moves into congruence with the sample application area 100 and is able to relax into its cavity (cf. reference numeral 12′ and arrow). The expanded element 12′ substantially fills the cavity of the sample application area 100 or is only slightly smaller than it. As a result of the expansion or increase in volume of the element 12 into the sample application area 100 the sample liquid P contained therein is displaced into the microchannel 102 and hence also into the cavity of the sample utilisation area 101 (cf. P′).

Depending on the dimensions of the cavities of the sample application area 100, sample utilisation area 101 and the microchannels 102, 103, the sample liquid P′ displaced into the sample utilisation area 101 also passes through the microchannel 103 into other cavities (not shown in detail) which in some cases may also be needed for other subsequent reactions. Also, as the sample liquid P is displaced by the element 12 expanding into the cavity of the sample application area 100, the additional seal 13 essentially prevents sample liquid P from escaping outwards from the cover 11.

In the embodiment shown the cover 11 is designed so that it is held in the opened position (FIGS. 1a, b) by suitable latching or fixing means (not shown) in the position illustrated and the cover 11 can only be moved after a specific force has been overcome. After the cover 11 has been closed (FIG. 1d) this is no longer possible, with the result that reliable closing of the sample application area 100 by the biosensor 1 used once is guaranteed. However, it would be possible to make the movement described above reversible, by equipping the element 12 with suitable bevels, for example.

In the embodiment shown in FIGS. 1a to d, the element 12 of changeable volume and/or shape acts virtually as an overpressure pump for initiating a movement of the sample liquid P between the sample application area 100 and at least the sample utilisation area 101.

FIGS. 2a to e now show a second embodiment of a microfluidic platform according to the invention in the form of a biosensor 2. The biosensor 2 also comprises a base member 20 comparable in shape to the base member 10, and provided at its left-hand end with a substantially circular cavity 200. The cavity 200 is connected via a microchannel 202 with the substantially circular cavity of a sample utilisation area 201. The sample utilisation area 201 is in turn connected via a microchannel 203 to the substantially circular cavity of a sample application area 204. The sample application area 204 is upwardly open and allows a sample liquid P to be introduced (cf. FIG. 2a).

However, for this purpose the microchannels 202, 203 and also the sample utilisation area are closed off at the top by a cover film 24 which is, for example, adhered to the base member 20. On the left-hand side of the base member 20 a cover 21 is movably connected thereto. The cover 21 is in an extended position, in the position shown in FIGS. 2a to 2b, and in turn comprises an upper cover part 210, a lower cover part 211 and a rear cover wall 212. These parts may in turn be joined together in several sections or may be constructed in one piece. In the upper cover part 210 is formed a substantially circular cavity 213 in which, in turn, a substantially circular element 22 of changeable volume and/or shape is held. The element 22 substantially fills the cavity 200 of the base member 20 in the position of the cover 21 shown in FIGS. 2a and b.

It is also apparent that the element 22 has a bevel 220, which is provided on the side facing the cavity 200 and in the direction of movement, i.e., on the right (cf. the arrows) in the Figures.

In the embodiment shown in FIG. 2, FIG. 2a shows a first process step (S1′) in which the cavity 200 is substantially filled by the element 22. In a second step S2′ (FIG. 2c) the cover 21 is pushed to the right in the direction of the base member 20. The pushing is assisted by the bevel 220. At the same time the element 22 is compressed by the opening edge of the cavity 200 and moved out of the cavity 200 (cf. arrow and reference numeral 22′). The volume of the element 22 thus decreases at the same time. Obviously, as in the case of the embodiment shown in FIG. 1, combined forms are possible in which there is a certain change of shape in addition to a change of volume of the element 22 that occurs primarily.

As in the embodiment according to FIG. 1, a film-like seal 23 is also provided in the embodiment shown in FIG. 2, this seal 23 surrounding the cavity 213 of the upper cover part 210. The seal 23 reinforces the sealing action of the cover 21, with the result that during the compression of the element 22 into the compressed state (22′) and hence opening up of the volume of the cavity 200, underpressure is produced in the cavity 200 and hence the sample liquid P is aspirated out of the sample application area 204 in the direction of the cavity 200 fluidically connected thereto. As the sample utilisation area 201 is provided in front of the cavity 200 in the direction of flow of the sample liquid P, the sample liquid P passes from the sample application area 204 through the microchannel 203 initially to the sample utilisation area 201.

In the embodiment shown in FIG. 2, the element 22 of changeable volume and/or shape thus acts as a virtual vacuum pump for transferring sample liquid P from the sample application area 204 to the sample utilisation area 201 (cf. P′ in FIGS. 2c and d).

Also provided in the embodiment shown in FIG. 2 are latching means (not shown in detail) which hold the cover 21 in the open position shown in FIG. 2a or b and enable the cover to be moved along only by the application of a certain releasing force. Similarly in the closed position of the cover 21 shown in FIG. 2d, suitable means are provided for ensuring that the cover 21 is held in this position. However, in this embodiment too, applications are conceivable in which repeated opening and closing of the cover 21 is desirable. Here (as in the embodiment shown in FIG. 1) particular value would be placed on the suitable choice of material for the element 22 of changeable volume and/or shape, to enable this element to perform the reversible movements, repeatedly if necessary.

FIGS. 3a to e show a third embodiment of a microfluidic platform according to the invention. A biosensor 3 is shown which in turn shows a base member 30 comparable in shape with the base members 10 and 20 and a cover 31 that is movably connected thereto. The base member 30 of the biosensor 3 is in turn shown only partly (in the region of the cover 31) and comprises there a sample application area 300 for the application of a sample liquid P which is fluidically connected through a microchannel 302 to a sample utilisation area 301. From the sample utilisation area 301 runs another microchannel 303 which is able to connect the sample utilisation area 301 to other cavities or venting devices (not shown in detail). The sample utilisation area 301 and the microchannels 302 and 303 are covered at the top by a suitable cover film 34.

The cover 31 comprises an upper part 310, a lower part 311 and a rear wall 312, similarly to the other embodiments.

Also provided in the upper cover part 310 is a substantially circular through-opening 313. An element 32 of changeable volume and/or shape in the form of a membrane-like part is mounted in the upper part of the through-opening 313, preferably by adhesive bonding or welding.

Moreover, on the underside of the upper cover part 310 there is also provided a film-like seal 33 which surrounds the opening 313. In this embodiment as well, suitable means (not shown in detail) are provided which secure the cover 31, preferably by latching, in its open position shown in FIGS. 3a and b or in its closed position (FIGS. 3c and d).

If the cover 31 is now pushed to the right, in the direction of the base member 30, until it reaches the end stop, by the application of a releasing force (step S1″, FIG. 3c), the opening 313 of the cover 31 is brought into approximate congruence with the sample application area 300. In this position a volume V is formed by the opening 313 and the cavity of the sample application area 300, this volume V being delimited at the top by the membrane-like element 32.

At the same time the volume V is sealed off to the outside by the cover 31, the sealing action being further reinforced by the above-mentioned seal 33.

If in a further step the membrane-like element 32 is pressed down (S2″, 32′, FIG. 3d), the volume V is reduced (V′). The consequence of this is that the sample liquid P located under the membrane-like element 32 is pumped through the microchannel 302 into the sample utilisation area 301 (P′).

In the embodiment shown in FIG. 3 the element 32 of changeable volume and/or shape thus acts as a virtual manual diaphragm pump. It should be pointed out that after the release of the pressure on the element 32′ the latter returns to its original shape (32). As a result, the volume situated under the membrane-like element 32 is naturally increased again, so as to obtain a bidirectional pumping mechanism (which may be desirable in certain cases).

Finally it should be pointed out that the embodiments shown in FIGS. 1 to 3 always show only one element of changeable volume and/or shape which is held in a cover. However it is thoroughly possible and advantageous if one or more covers are provided which are movably connected to the microfluidic platforms and a plurality of elements of changeable volume and/or shape are held in the covers. This makes it possible to initiate a plurality of pumping operations simultaneously, by a movement of the cover or covers.

Thus FIG. 4 describes an embodiment of a biosensor 4 which comprises a base member 40 with a plurality of sample application areas 400 and a plurality of sample utilisation areas 401. The sample utilisation areas 401 are connected to the sample application areas 400 by corresponding microchannels 402. A suitable cover film 403 is provided for covering the microchannels 402 and the sample utilisation areas 401. No venting means are shown.

Moreover, a cover 41 is slidably connected to the base member 40 and has a plurality of elements 42 of changeable volume and/or shape which may, for example, be configured in the manner of the element 12 shown in FIG. 1. If the cover 41 is slid to the right in the direction of the base member 40, the elements 42 move into a position of congruence with the sample application areas 400, expand into them and displace a sample liquid that has been introduced into them in the direction of the microchannels 402 or the sample utilisation areas 401. Thus, by one movement of the cover 41, three pumping operations can be initiated simultaneously.

It is, of course, possible to provide a movable connection of the above-mentioned covers with the base members of the microfluidic platforms by some other method. For example, instead of a sliding movement, a rotary or hinged movement may also be provided.

The microfluidic platforms 1 to 4 described are preferably made of plastics, using the known plastics processing methods, particularly injection moulding. The films 14, 24, 34 and 403 that cover the cavities and microchannels formed in the base members 10 to 40 may be, for example, self-adhesive films or films provided with hot-melt adhesives which are laminated onto the surface of the base members. Alternatively it is also possible, of course, to use fixed covers for the covering, attached to the base members for example by UV adhesion, ultrasound welding, laser welding or high frequency welding.

### LIST OF REFERENCE NUMERALS

1 biosensor
10 base member
100 sample application area
101 sample utilisation area
102 microchannel
103 microchannel
11 cover
110 upper cover part
111 lower cover part
112 rear wall of cover
113 recess in upper cover part
12, 12′ element of changeable volume and/or shape
13 seal
14 cover film
2 biosensor
20 base member
200 cavity in the base member
201 sample utilisation area
202 microchannel
203 microchannel
204 sample application area
21 cover
210 upper cover part
211 lower cover part
212 rear wall of cover
213 cavity in the upper cover part
22, 22′ element of changeable volume and/or shape
220 bevel of the element of changeable volume and/or shape
23 seal
24 cover film
3 biosensor
30 base member
300 sample application area
301 sample utilisation area
302 microchannel
303 microchannel
31 cover
310 upper cover part
311 lower cover part
312 rear wall of cover
313 opening of the upper cover part
32 element of changeable volume and/or shape
33 seal
34 cover film
4 biosensor
40 base member
400 sample application areas
401 sample utilisation areas
402 microchannels
403 cover film
41 cover
42 element of changeable volume and/or shape
43 seal
P, P′ sample liquid
S1,S2 process steps
S1′,S2′ process steps
S1″,S2″ process steps
V, V′ volume limited by membrane

1. Microfluidic platform (1, 2, 3, 4) having at least one means (12, 22, 32, 42) for initiating a movement of a liquid (P), in particular a sample liquid, between at least two locations (100, 101; 204,201; 300,301; 400, 401) of the microfluidic platform (1, 2, 3, 4), characterised in that the at least one means (12, 22, 32, 42) encompasses at least one element of changeable volume and/or shape (12, 22, 32, 42), which is mounted on at least one component (11, 21, 31, 41) movably connected to the microfluidic platform (1, 2, 3, 4) and by movement of the component (11, 21, 31, 41) can be brought into a position such that the element (12, 22, 32, 42), by changing its volume and/or shape, causes the liquid (P) situated at the at least one location (100, 204, 300, 400) to be moved at least partly from this location (100, 204, 300, 400) to the at least one other location (101, 201, 301, 401).

2. Microfluidic platform (1, 2, 3, 4) according to claim 1, characterised in that the at least one element of changeable volume and/or shape (12, 22, 32, 42) by movement of the component (11, 21, 31, 41) can be brought into a position such that the element (12, 22, 32, 42), by an increase in volume (12′), at least partly fills at least one cavity (100, 400) or by a reduction in volume (22′) at least partly opens up at least one cavity (200) that has previously been at least partly filled by the element (22) or, by a change in the shape of the element (32′), the volume (V) of at least one cavity (300 and 313) at least partly delimited by the element (32) can be changed (V′).

3. Microfluidic platform (1, 2, 3, 4) according to claim 1, characterised in that the component (11, 21, 31, 41) is of a cover-like configuration and in at least one position covers at least one cavity (100, 200, 300, 400).

4. Microfluidic platform (1, 2, 3, 4) according to claim 1, characterised in that the cover-like component (11, 21, 31, 41) covers the microfluidic platform (1, 2, 3, 4) at least from two opposite sides.

5. Microfluidic platform (1, 2, 3, 4) according to claim 1, characterised in that the cover-like component (11, 21, 31, 41) is slidably or pivotably connected to the microfluidic platform (1, 2, 3, 4).

6. Microfluidic platform (1, 2, 3, 4) according to claim 1, characterised in that at least one sealing device (13, 23, 33, 43) is provided, such that in the at least one position of the cover-like component (11, 21, 31, 41) covering the at least one cavity (100, 200, 300, 400) the covered cavity (100, 200, 300, 400) is outwardly sealed.

7. Microfluidic platform (1, 2, 3, 4) according to claim 1, characterised in that the sealing device (13, 23, 33, 43) is provided on the cover-like component (11, 21, 31, 41) on the side facing the at least one cavity (100, 200, 300, 400) that is to be covered.

8. Microfluidic platform (1, 2, 3, 4) according to claim 1, characterised in that the cover-like component (11, 21, 31, 41) comprises at least one cavity (113, 213) or opening (313), in which the at least one element of changeable volume and/or shape (12, 22, 32, 42) is at least partly held.

9. Microfluidic platform (1, 4) according to claim 2, characterised in that the element of changeable volume and/or shape (12,42) is compressed in a first position of the cover-like component (11, 41) that exposes the cavity (100, 400) and the cover-like component (11, 41) can be brought into a second position in which the cavity (100, 400) is sealingly covered and the element of changeable volume and/or shape (12, 42) has relaxed into the cavity (100, 400), the cavity (100, 400) being fluidically connected to at least one other cavity (101, 401), particularly a sample utilisation area.

10. Microfluidic platform (1, 4) according to claim 9, characterised in that the cavity (100, 400) is a sample application area of a technical medical measuring instrument, for example, a microfluidic cartridge, a test strip or the like.

11. Microfluidic platform (2) according to claim 2, characterised in that the element of changeable volume and/or shape (22), in a first position of the cover-like component (21), has relaxed into a cavity (200) of the microfluidic platform (2) and the cover-like component (21) can be brought into a second position that sealingly covers the cavity (200), in which the element of changeable volume and/or shape (22) has freed up the cavity (200) again and has been compressed, the cavity (200) of the microfluidic platform (2) being fluidically connected to at least one other cavity (201, 204), particularly a sample utilisation area (201) and/or a sample application area (204).

12. Microfluidic platform (2) according to claim 11, characterised in that the element of changeable volume or shape (22) comprises bevels (220) on the side facing the cavity (200).

13. Microfluidic platform (3) according to claim 2, characterised in that the element of changeable volume and/or shape (32) is of membrane-like configuration and the cover-like component (31) can be brought into a position in which at least one cavity (300+313) is sealingly covered and wherein the membrane-like element (32) at least partly delimits the at least one cavity (300+313), while pressure on the membrane-like element (32) causes a reduction (V′) in the volume (V) of the at least one cavity (300+313) limited thereby (32) at least in parts.

14. Microfluidic platform (4) according to claim 2, characterised in that it (4) comprises a plurality of cavities (400) and a plurality of elements of changeable volume and/or shape (42) are provided, which are mounted on the at least one component (41) that is movably connected to the microfluidic platform (4).

15. Method of initiating a movement of a liquid (P), particularly a sample liquid, between at least two locations (100, 101; 204,201;
300,301; 400, 401) of a microfluidic platform (1, 2, 3, 4), having t least one means (12, 22, 32, 42) for initiating a movement of a liquid (P), in Particular a sample liquid, between at least two locations (100, 101; 204,201; 300,301; 400, 401) of the microfluidic platform (1, 2, 3, 4), characterised in that the at least one means (12, 22, 32, 42) encompasses at least one element of changeable volume and/or shape (12, 22, 32, 42), which is mounted on at least one component (11, 21, 31, 41) movably connected to the microfluidic platform (1, 2, 3, 4) and by movement of the component (11, 21, 31, 41) can be brought into a position such that the element (12, 22, 32, 42), by changing its volume and/or shape, causes the liquid (P) situated at the at least one location (100, 204, 300, 400) to be moved at least partly from this location (100, 204, 300, 400) to the at least one other location (101, 201, 301, 401), said method being characterised by at least the following process steps:
at least one cavity (100, 200, 300, 400) is sealingly covered (S1, S1′, Si″) by at least one component (11, 21, 31, 41) which is movably connected to the microfluidic platform (1, 2, 3, 4)
least one element of changeable volume and/or shape (12, 22, 32, 42) mounted on the at least one component (11, 21, 31, 41) movably connected to the microfluidic platform (1, 2, 3, 4), is changed in its volume and/or in its shape (S2, S2′, S2″such that a liquid (P) located in the at least one cavity (100, 200, 300, 400) is at least partly moved out of the cavity (100, 300, 400) or such that a liquid (P) is moved at least in the direction of this cavity (200).

16. Method according to claim 15, characterised in that the at least one element of changeable volume and/or shape (12, 22, 32, 42) is brought, by movement of the component (11, 21, 31, 41), into a position such that the element (12, 42), by increasing in volume, at least partly fills the at least one cavity (100, 400) or by decreasing in volume, at least partly frees up the at least one cavity that has previously been at least partly filled by the element (22) or, by a change in the shape of the element (32), the volume (V) of at least one cavity (300, 313) that is at least partly delimited by the element (32) is altered (V′).

17. Method according to claim 15, characterised in that the element of changeable volume and/or shape (12, 42) is compressed in a first position of the cover-like component (11, 41) that frees up the cavity (100, 400) and the cover-like component (11, 41) is brought into a second position, in which the cavity (100, 400) is sealingly covered and the element of changeable volume and/or shape (12, 42) relaxes into the cavity (100, 400), the cavity (100, 400) being fluidically connected to at least one other cavity (101), particularly a sample utilisation area.

18. Method according to claim 15, characterised in that the element of changeable volume and/or shape (22) in a first position of the cover-like component (21) is relaxed into a cavity (200) of the microfluidic platform (2) and the cover-like component (21) is brought into a second position that sealingly covers the cavity (200), in which the element of changeable volume and/or shape (22) has freed up the cavity (200) again and has been compressed, the cavity (200) of the microfluidic platform (2) being fluidically connected to at least one other cavity (201, 204), particularly to a sample utilisation area (201) and a sample application area (204).

19. Method according to claim 15, characterised in that the element of changeable volume and/or shape (32) is of membrane-like configuration and the cover-like component (31) is brought into a position in which at least one cavity (300+313) is sealingly covered and wherein the membrane-like element (32) at least partly delimits the at least one cavity (300+313), while as a result of pressure on the membrane-like element (32) the volume (V) of the at least one cavity (300+313) at least partly delimited thereby is reduced (V′).
